(19) United States
(12) Patent Application Publication
(10) Pub. No.: US 2023/0325826 A1
(43) Pub. Date: Oct. 12, 2023

(54) Process for Creation authentication/storage/retrieval of immutable NFT documents on a decentralized proof-of-stake blockchain

(71) Applicant: David Exline, Gibsonia, PA (US)

(72) Inventor: David Exline, Gibsonia, PA (US)

(21) Appl. No.: 18/135,126

(22) Filed: Apr. 15, 2023

Related U.S. Application Data
(60) Provisional application No. 63/327,861, filed on Apr. 6, 2022.

(51) Int. Cl. G06Q 20/38; G06Q 20/36; G06Q 20/40

(52) U.S. Cl. CPC G06Q 20/389; G06Q 20/36; G06Q 20/401

(57) ABSTRACT

A method related to a novel approach to store, organize, retrieve and authenticate immutable NFT (Non-fungible token) documents on a decentralized proof-of-stake blockchain. This intelligent platform is the following step process where every submission carries its own unique, immutable identity. This process applies the concept to grant users access to a unique decentralized, non-custodial digital document storage solution on the market. The process remains focused on cultivating robust systems around minting, validating, authenticating, retrieving & verifying NFT-based documentation. This is accomplished by the described method to mint, archive, and retrieve NFT documents using a proof-of-stake blockchain as its basis and native tokens as a mode of transaction.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The invention relates to the field of blockchain technology and, more specifically, to a process of creation/authentication/storage/retrieval of immutable NFT (Non-fungible token) documents on a decentralized proof-of-stake blockchain is proposed.

### Description of the Related Art

Online identity verification continues to be the leading challenge for businesses and individuals who desperately want to provide value over the internet. The problem is that any digital asset placed on the internet will be copied and anonymously distributed across the globe instantly. Artists know this all too well through the constant threat of pirated songs, movies, and artworks, and they have since been forced to adopt the sub-optimal streaming model to compensate.

But now, online artists and netizens have finally found a way to fight back against online pirates, which is the development of NFT. With the evolution of blockchain technology, Non-Fungible Tokens (NFTs) have become the leading alternative asset in the world, providing unparalleled security & immutability.

As congestion increases throughout the digital revolution, proof-of-work blockchain ecosystems like Ethereum will continue to demonstrate non-viability due to high transactional fees, congestion, and lack of security. As a result, the maturity of the proof-of-stake (POS) consensus algorithm within a proof-of-stake (POS) Blockchain has created an environment that allows us to leverage the most robust blockchain ecosystem, taking advantage of inexpensive processing fees for NFT minting & storage.

This technology allows us to develop protocols that validate, authenticate, transfer, retrieve, and verify documentation by utilizing NFTs (Non-Fungible Tokens) as the basis for document creation & storage. Every submission carries its own unique immutable identity.

Multiple solutions have been presented in prior art regarding the effective utilization of digital technology with effective authentication systems. However, these solutions are limited and restricted to their conventional systems and are not supporting the ever-changing dynamics. NFTs serves as a certificate of authenticity for digital artifacts. Each NFT, or token, has a unique set of characteristics with an independent value that cannot be duplicated on the blockchain

The proposed invention aims to provide a one-of-a-kind system that grants users access to a unique decentralized, non-custodial digital document storage solution. This process remains focused on cultivating robust systems around minting, validating, retrieving, & verifying NFT-based documentation, unlike the conventional handwritten or electronic signatures used by the most influential companies, small businesses sole-proprietorships.

None of the previous inventions and patents, taken either singly or in combination, is seen to describe the instant invention as claimed. Hence, the inventor of the present invention proposes to resolve and surmount existing technical difficulties to eliminate the shortcomings mentioned above of prior art.

### SUMMARY

In light of the disadvantages of the prior art, the following summary is provided to facilitate an understanding of some of the innovative features unique to the present invention, and it is not intended to be a complete description. A full appreciation of the various aspects of the invention can be gained by taking the entire specification, claims, drawings, and abstract.

The primary desirable object of the present invention is to provide a novel and improved method for securely designed applications which is based on NFTs who serve as a certificate of authenticity for digital artifacts. Each NFT, or token, has a unique set of characteristics with an independent value that cannot be duplicated on the blockchain

The invention's primary objective is to provide a smart methodology directed to devices, systems, and methods for facilitating method for document minting via decentralized applications created to ensure the security and authenticity of documents.

Another objective of the invention is to provide Native Tokens allowing users to mint documents as an immutable NFT (Non-Fungible Token) on the proof of stake Blockchain, paid for through user wallet access with native tokens.

It is also the objective of the invention to allow the minting transaction to hold the document, which will be submitted and verified on the blockchain, and stored within the decentralized non-custodial vault for retrieval.

it is further the objective of the invention to provide financial comfort to users by saving gas fees with the same security and authentication procedures.

Other aspects, advantages, and novel features of the present invention will become apparent from the detailed description when considered in conjunction with the accompanying drawings.

This summary is provided merely to summarize some example embodiments to provide a basic understanding of some aspects of the subject matter described herein. Accordingly, it will be appreciated that the above-described features are merely examples and should not be construed to narrow the scope or spirit of the subject matter described herein. Other features, aspects, and advantages of the subject matter described herein will become apparent from the detailed description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 shows the process for creation/authentication/storage/retrieval of immutable NFT (Non-fungible Token) documents on a decentralized proof of stake blockchain in accordance with the present invention.

FIG. 2 is another process view in accordance with the present invention.

Skilled artisans will appreciate those elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. However, it is to be understood that the present invention may be embodied in various forms. Therefore, specific details disclosed herein are not to be interpreted as limiting but rather as a basis for the claims and a representative basis for teaching one skilled in the art to employ the present invention in virtually any appropriately detailed system, structure, or manner.

The terminology used herein is to describe particular embodiments only and is not intended to limit the invention. The term “and/or” includes any combinations of one or more of the associated listed items. As used herein, the singular forms “a,” “an,” and “the” are intended to include the plural forms as well as the singular forms unless the context indicates otherwise. It will be further understood that the terms “comprises” and/or “comprising,” when used in this specification, specify the presence of stated features, steps, operations, elements, and/or components but do not preclude the presence or addition of one or more other features, steps, operations, elements, components, and/or groups thereof.

NFTs comes with a monetary cost called gas fees and a high cost to the environment through carbon emissions. Because of the massive amount of computing power needed to process and validate transactions on the blockchain, the energy costs are offset by way of gas fees—the monetary fee charged by NFT trading platforms for minting a token, as well as the fee for buying and selling; not to mention, users are also charged conversion fees to their digital wallet providers.

The gas prices change throughout the day depending on overall energy consumption. Still, it could rack up quickly and, in some cases, get up to a couple of hundred dollars for a relatively low-value transaction. The proposed process provides a novel method for creating/authentication/storage/retrieval of immutable NFT (Non-fungible token) documents on a decentralized proof-of-stake blockchain to offset the energy consumption and carbon footprint.

As per its preferred embodiments, the system is a one-of-a-kind system that grants users access to a unique decentralized, non-custodial digital document storage solution. The process involves cultivating robust systems around minting, validating, retrieving, & verifying NFT-based documentation.

As per its further embodiments, the process allows document minting via a decentralized application created to ensure the security and authenticity of documents. Native Tokens allow users to mint documents as an immutable NFT (Non-Fungible Token) on the proof of stake Blockchain, paid for through user wallet access with native tokens. At this point, the minting transaction holding the user's document will be submitted and verified on the blockchain and stored within a decentralized non-custodial vault for retrieval.

As per its further embodiments, the process involves blockchain as both an audit trail and document version tracking system. Each epoch (block) represents an earlier version of the immutable document, enabling anyone to backtrack its history for verification.

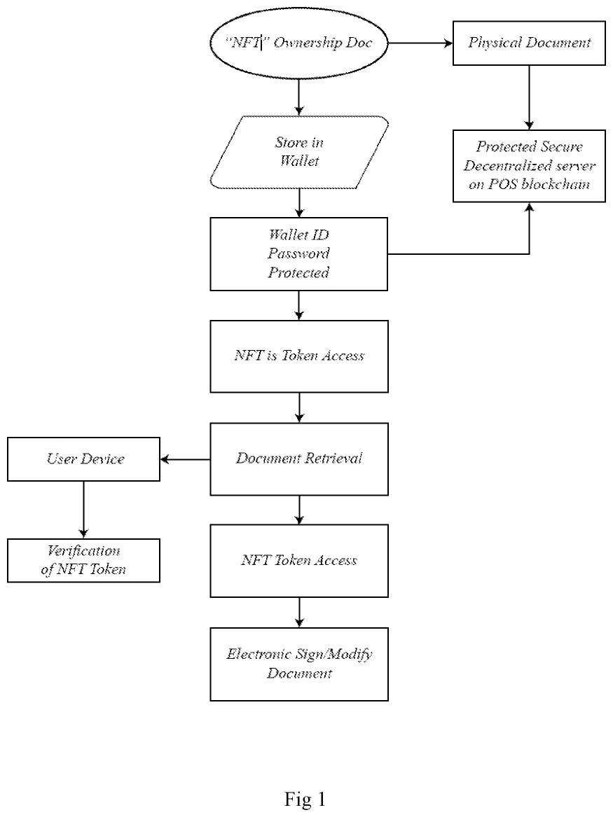

The FIG. 1 shows the process flow wherein the NFT Ownership document is stored in a wallet and a unique Wallet ID and password is generated to ensure privacy. In case it is a physical document, a protected secure decentralized server on the POS blockchain will ensure the protection through ID and password. Once a unique ID is generated NFT can be accessed anytime for document retrieval wherein verification of the NFT token will be required. To modify the document, an electronic signature is required as well.

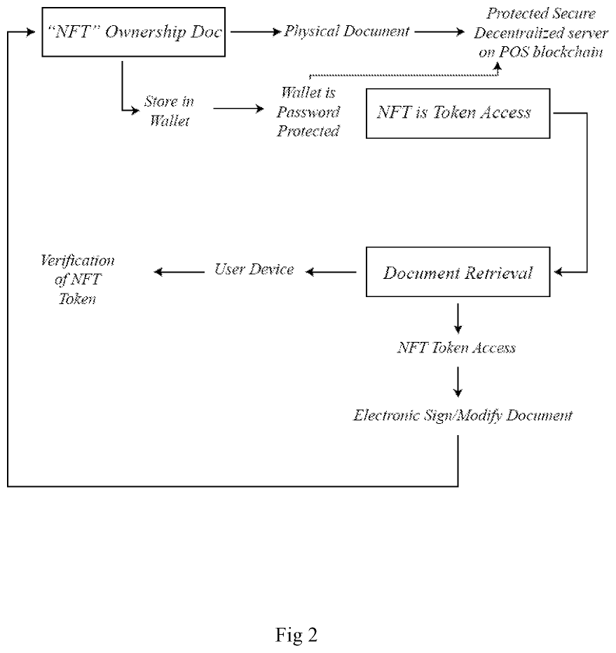

FIG. 2 shows the process for the creation of NFT documents wherein the NFT ownership document can either be stored in a wallet or is protected by a password and secured at a Decentralized server on the POS blockchain system. In the case of a physical document, it is also stored at a protected and secure decentralized server on the POS blockchain system. The NFT acts as token access and is used to retrieve the document. NFT token access is also required to modify the document.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to it without departing from its spirit. Therefore, it is not intended that the scope of the invention be limited to the specific embodiment illustrated and described. Instead, it is intended that the appended claims and their equivalents determine the scope of this invention.

The Abstract of the Disclosure is provided to allow the reader to quickly ascertain the technical disclosure's nature. It is submitted with the understanding that it will not be used to interpret or limit the scope or meaning of the claims. In addition, in the preceding Detailed Description, it can be seen that various features are grouped in various embodiments to streamline the disclosure. This method of disclosure is not to be interpreted as reflecting an intention that the claimed embodiments require more features than are expressly recited in each claim. Instead, as the following claims reflect, the inventive subject matter lies in less than all features of a single disclosed embodiment. Thus, the following claims are incorporated into the Detailed Description, with each claim standing on its own as a separately claimed subject matter.

1: A computer-implemented method for creating a digital platform where a process for creation/authentication/storage/retrieval of immutable NFT (Non-fungible token) documents on a decentralized proof-of-stake blockchain is provided comprising:
A method the following claim 1, wherein minting of documents as immutable NFT (Non-Fungible Tokens) on a Proof-of-Stake Blockchain;
A method following a claim 1, wherein payment for minting NFT on the Proof-of-Stake Blockchain through user wallet access with a digital currency known as tokens (i.e., utility tokens, security tokens, or non-fungible tokens);
A method following claim 1, wherein payment for minting NFTs on the Proof-of-Stake Blockchain through user wallet access with Native Tokens is provided;
A method following a claim 1, wherein minting transaction holding documents will be submitted and verified on the Proof-of-Stake Blockchain and stored within the user decentralized non-custodial vault for retrieval;
A method following a claim 1, wherein authentication of NFT documents will be verified on the Proof-of-Stake Blockchain;
A method following claim 1, wherein verified documents on the Proof-of-Stake Blockchain will be utilized as electronic signatures; and
A method the following claim 1, wherein minting of documents as NFTs on the Proof-of-Stake Blockchain includes but is not limited to legal documents such as wills, agreements or peer-to-peer contracts, professional certifications, marriage certificates, medical records, driver's license or identity verification, professional licensing, design or utility patents, intellectual property (IP), company or legal documentation, corporate contracts, business records or reports, consumer or internal reviews, purchase orders, company agreements or collaborations, employee contracts or agreements, regulatory and budgetary storage/authentication, confidential internal documents, books, flyers, videos, artwork, physical property deeds, medical records or licenses and 3rd party NFTs is provided.
